(19) United States
(12) Patent Application Publication
(10) Pub. No.: US 2007/0059146 A1
(43) Pub. Date: Mar. 15, 2007

(54) Loading implement

(76) Inventor: Marcus Bitter, Mannheim (DE)

Correspondence Address: DEERE & COMPANY, ONE JOHN DEERE PLACE, MOLINE, IL, 61265, US

(21) Appl. No.: 11/504,432

(22) Filed: Aug. 15, 2006

(30) Foreign Application Priority Data
Aug. 19, 2005 (DE) 10 2005 039 251.2

(51) Int. Cl. B66C 23/00

(52) U.S. Cl. 414/685

(57) ABSTRACT

A loading implement is provided with a hydraulic arrangement for the spring support of a boom. The hydraulic arrangement is provided with at least one hydraulic conveying device, a hydraulic fluid tank, a first hydraulic cylinder and a control implement for the lifting and lowering of the boom, as well as a controllable pressure limiting arrangement that is arranged and configured in such a way that excursion movements of the first hydraulic cylinder can be equalized. The equalization is performed by a control unit for the control of the pressure limiting arrangement. In order to correct the spring support performance of the hydraulic arrangement when a change in the loading of the hydraulic cylinder occurs, devices are provided with which a change in the loading condition of the boom can be detected as well as a signal reproducing the loading condition can be generated and that the signal reproducing the loading condition can be processed by the control unit.

### FIELD OF THE INVENTION

The invention concerns a loading implement with a hydraulic arrangement for the spring support of a boom, where the hydraulic arrangement includes at least one hydraulic conveying device, a hydraulic tank, a first hydraulic cylinder and a control implement for raising and lowering the boom, as well as a controllable pressure limiting arrangement that is arranged and configured in such a way that excursion movements of the first hydraulic cylinder can be equalized and that the implement includes a control unit for the control of the pressure limiting arrangement.

### BACKGROUND OF THE INVENTION

Hydraulic arrangements are known that can be applied to the hydraulic spring support of a boom of a loading implement, for example, a front loader, wheel loader, telescopic loader, excavator, crane vehicle or similar loading implements. Hydraulic arrangements of this type are based on a so-called passive hydraulic spring support system with a pressurized hydraulic accumulator or on a so-called active or semi-active spring support system in which a controllable pressure limiting arrangement or a pressure limiting arrangement that can be regulated is applied.

A semi-active hydraulic spring support system is described, for example, in EP 1496009 A1. There a hydraulic spring support system is described, in particular for a boom of a loading implement, with a hydraulic cylinder, provided with at least one chamber, and a control implement that establishes a selective connection with a hydraulic fluid pump and a hydraulic fluid tank over at least one hydraulic line with the at least one chamber. Moreover the system contains a connecting line that permits a connection of the at least one chamber to the hydraulic fluid tank and contains a first stop valve. Further a pressure limiting unit is provided in the connecting line, it can be controlled over a control unit as a function of the signal of a position sensor. The spring support system disclosed by EP 1496009 A1 reacts to excursion movements of a hydraulic piston and counteracts the excursion movements with the aid of the control unit and the controllable pressure limiting unit.

The disadvantage here is that when the pressure of the hydraulic cylinder is reduced with an active spring support, this cannot be recognized by the spring support system. Then the spring support system is necessarily affected negatively, since the spring support performance would become considerably stiffer. The result would be that only strong or very strong impact would permit the pressure limiting unit to open. In an extreme case the boom would no longer deflect. Such a case can occur, for example, if the tool holder is unloaded manually when the machine is running and the spring support is activated, if the shovel is emptied during the operation, the boom is retracted or the shovel is emptied to the side during the operation.

Accordingly, there is a clear need in the art to create a loading implement with a hydraulic arrangement for the spring support of a boom, in which a reduction of the pressure in the first hydraulic cylinder does not negatively affect the spring support performance of the hydraulic arrangement.

### SUMMARY OF THE INVENTION

According to the invention a loading implement of the type cited initially is provided with devices with which changes in the loading condition of the boom can be detected as well as a signal reproducing the loading condition that can be generated. The signal reproducing the loading condition is processed by the control unit for the control or regulation of the pressure limiting arrangement and utilized for the correction of the pressure threshold that determines the spring support performance for the pressure limiting arrangement. The means for detecting changes in the loading condition of the boom include devices for the detection of changes on the basis of geometrical changes to the boom, for example, of changes to an adjustment angle or length of extension, as well as devices for detecting changes on the basis of loading conditions, for example, due to emptying of a loader shovel. The following should include the loading conditions referring to the boom as well as changes in those loading conditions and be analogous to the loading conditions applied to the boom or load changes. In other words: a change in load or the loading condition should analogously include a loading change or a loading condition. The signal reproducing the loading condition of the boom is directly connected with the loading condition of the first hydraulic cylinder, since the boom is raised, lowered or held by the hydraulic cylinder. If the loading condition of the boom changes, whether due to changes in length (extending/retracting) or changes in the adjustment angle (raising/lowering) of the boom or due to direct changes in the load at the tool or the tool holder, then this results directly in a change in the loading condition of the first hydraulic cylinder. Whenever the boom or the hydraulic cylinder is connected rigidly to the frame of the loading implement, changes in the loading condition at the boom also result in changes in the entire weight distribution on the loading implement and therewith also on the frame and the axles, etc. Thereby the result is many varied possibilities for the determination of the loading condition of the boom or the determination of the loading condition of the first hydraulic cylinder. By generating a signal corresponding to the loading condition on the boom, that can be processed by the control unit, changes in the loading condition of the boom can be detected and considered by the control unit in the generation of control or regulating signals and included in the control or regulation of the pressure limiting arrangement that can be controlled or regulated, so that as a result the loading condition of the first hydraulic cylinder is considered and a corresponding pressure limiting adjustment is performed by the control unit at the pressure limiting arrangement in such a way that the spring support performance of the hydraulic spring support arrangement is optimized or that a change in the loading conditions does not result in a negative performance of the spring support arrangement. In that way, for example, if a spring support function is activated and the loading implement is operated simultaneously with a change in the loading condition on the boom, in that a loader shovel is emptied during the operation, the change in the loading condition of the boom can be detected and included in the control or regulation of the pressure limiting arrangement. In this actual case it would signify that on the basis of the reduction of the load on the boom the pressure of the load in the hydraulic cylinder is reduced and the spring support performance, adjusted upon the activation of the spring support arrangement, is too hard or too stiff for the new (lighter) loading condition. The control unit would thereupon react with a control signal for the reduction of the ruling pressure threshold value, so that the spring support performance would again conform to the original spring support performance.

The devices for the detection of changes in the loading conditions of the loading implement or the boom may include, for example, strain gages that are arranged on one or more axles of the loading implement, but preferably on a rear axle. By the application of strain gages the bending deflection of an axle can be measured and utilized for the measurement of the load on another axle, for example, the front axle. Thereby the loading condition of the loading implement and therewith also the loading condition of the boom can be determined with or without a load. In that way, for example, the bending deflection of the rear axle can be measured by means of a strain gage and the conclusion drawn therefrom how much weight is applied to the boom. Then as a function of the signals provided by the strain gage, corresponding signals can be generated by the control unit, in order to make the spring support system of the boom conform to the new loading conditions.

Strain gages can also be applied as means for the detection of changes in the loading conditions of the loading implement or the boom, these strain gages are arranged on the boom of the loading implement. Here the bending deflection of the boom is measured at an appropriate location and utilized as a measure of the loading condition. The greater the bending deflection of the boom, the greater must be the load on the boom or the load on the hydraulic cylinder. In case the boom is variable in its length, that is, it can be telescoped, then a change in the loading condition of the boom can be determined on the basis of the predetermined length, since in the normal case a change in the load of the hydraulic cylinder occurs when the length of the boom changes due to the change in the lever relations. In order to obtain a more exact definition of the loading condition of the boom, position sensors can moreover be applied by means of which the exact place or position of the boom can be determined with regard to the adjustment angle (pivot angle) and/or the extension length can be determined. Then the varying lever relations or force relations can be considered by means of the signals of the position sensors that arise from the manipulation of the boom (extension/retraction, lifting/lowering), these lever relationships affect the loading of the hydraulic cylinder as well as the determination of changes to the loading condition of the boom.

In a further embodiment the devices may include one or more pressure sensors that are arranged directly at the hydraulic cylinder. In this embodiment, for example, the pressure is measured on the lifting side of the lifting cylinder that is used for the raising and lowering of the boom. Here the pressure operating in the lifting cylinder can be used as a direct measure of the change in the load of the boom or the change in the loading of the hydraulic cylinder, where the pressure operating in the lifting cylinder is the actual value that directly affects the spring performance of the boom or of the loading implement.

It is also conceivable that the pressure on the lifting side of a further hydraulic cylinder be measured, this could, for example, be a tilting cylinder that is used for the tilting of a tool arranged on the boom. Simultaneously the exact position of the boom is determined. Once pressure and position values are determined, loading conditions can be detected and changes determined that can be included or considered in the control or regulation of the devices used for the correction of the spring support performance.

In a further embodiment the devices can include pressure sensors that are arranged at one or more hydraulic or pneumatic actuators preferably hydraulic cylinders that are preferably located between a frame and the axles of the loading implement. Such hydraulic cylinders can be applied in order to maintain or change an adjustable position of the frame with respect to a list or heeling relative to the ground under the loading implement or with respect to the axles. In addition these hydraulic cylinders can also be used to change the spring support of the axles of the vehicle in order to increase the operating comfort. Thereby the pressure in the hydraulic cylinders can be measured, these cylinders, for example, may retain the front axle of the vehicle in its position. The pressure acting on the lifting side of the cylinder can also be used as a measure for the determination of changes in the loading conditions, where, if necessary, the pressure on the lowering side of the cylinders can also be measured in order to compensate for a possible falsification of the measurement result due to a possible strain on the cylinder.

Alternatively it is also possible to apply switches in place of sensors, for example, position sensors or pressure sensors, in particular this would be position switches and/or pressure switches that transmit a corresponding signal for the determination of a loading condition of the boom upon actuation by a limiting pressure or by a mechanical release by a moving part.

To acquaint persons skilled in the art most closely related to the present invention, one preferred embodiment of the invention that illustrates the best mode now contemplated for putting the invention into practice is described herein by and with reference to, the annexed drawings that form a part of the specification. The exemplary embodiment is described in detail without attempting to show all of the various forms and modifications in which the invention might be embodied. As such, the embodiment shown and described herein is illustrative, and as will become apparent to those skilled in the art, can be modified in numerous ways within the spirit and scope of the invention—the invention being measured by the appended claims and not by the details of the specification.

### BRIEF DESCRIPTION OF THE DRAWINGS

For a complete understanding of the objects, techniques, and structure of the invention reference should be made to the following detailed description and accompanying drawings, wherein:

FIG. 1 is a schematic circuit diagram of a hydraulic arrangement for a semi-active spring support system with a controllable pressure limiting valve;

FIG. 2 is a schematic side view of a loading implement with a semi-active spring support system according to FIG. 1, as well as devices for the detection of changes in the loading condition;

FIG. 3 is a schematic cross section of a rear axle of a loading implement of FIG. 2 with further devices for the selection of changes in the loading conditions.

### DESCRIPTION OF THE PREFERRED EMBODIMENT

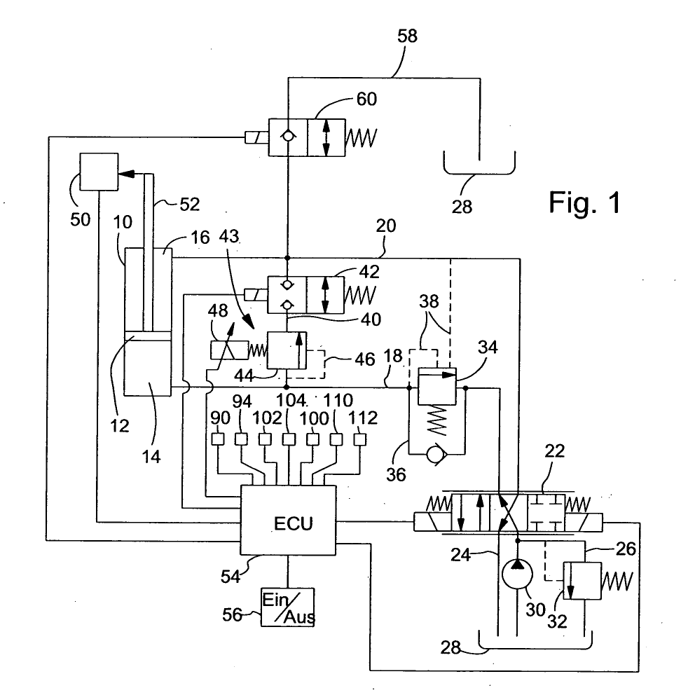

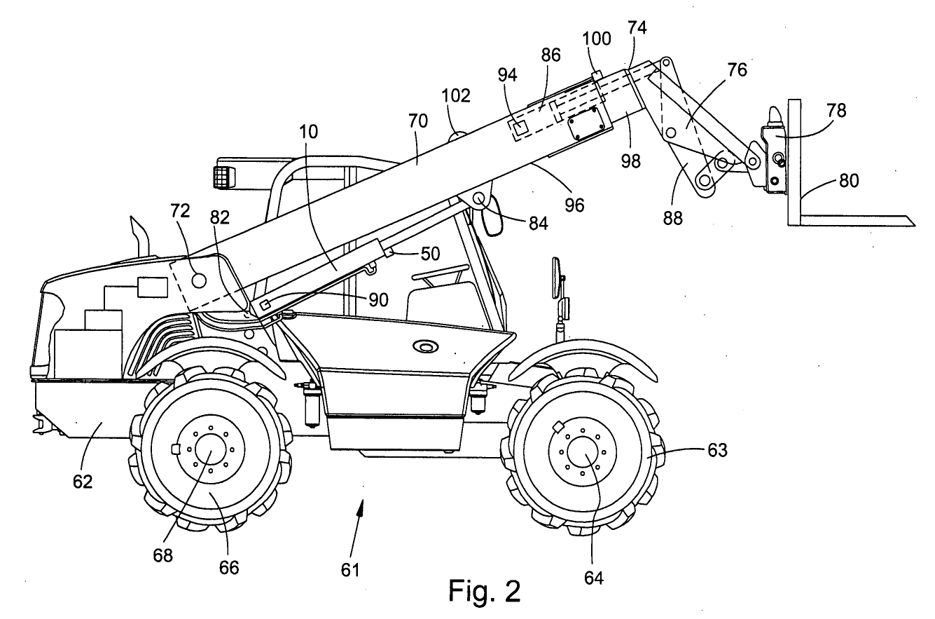

FIG. 1 shows a hydraulic cylinder 10 with a hydraulic piston 12 that is used for the lifting and lowering of a boom 70 of a loading implement 61 (both shown in FIG. 2).

The hydraulic cylinder 10 is provided with a lifting side chamber 14 and a lowering side chamber 16. The lifting side chamber 14 is connected with an electrically controllable control implement 22 over a lifting side hydraulic line 18 and the lowering side chamber 16 is connected with the control implement 22 over a lowering side hydraulic line 20.

The control implement 22 is connected with a hydraulic fluid tank 28 over a drain line 24 and over a pressure limiting line 26. A hydraulic fluid pump 30 conveys hydraulic fluid into each of the hydraulic lines 18, 20 over the control implement 22.

The control implement 22 can be switched into three positions, a closed position in which no hydraulic fluid flows into the hydraulic lines 18, 20, in a lifting position in which hydraulic fluid is supplied to the lifting side hydraulic line 18, and the lowering side hydraulic line 20 drains hydraulic fluid to the hydraulic fluid tank 28 and a lowering position in which the lowering side hydraulic line 20 is supplied with hydraulic fluid and the lifting side hydraulic line 18 drains hydraulic fluid to the hydraulic fluid tank 28.

The pressure limiting line 26 contains a pressure limiting valve 32, that opens upon reaching a limiting pressure and permits hydraulic fluid to flow between the hydraulic fluid pump 30 and the hydraulic fluid tank 28. In this way the hydraulic fluid pump 30 can still convey hydraulic fluid even with the control implement 22 closed.

The lifting side hydraulic line 18 contains a load holding valve 34, that permits a flow of hydraulic fluid in the direction of the hydraulic cylinder 10 over a bypass line 36. The load holding valve 34 is opened in the direction of the hydraulic fluid tank 28 over control lines 38, so that a flow of hydraulic fluid can take place to the hydraulic fluid tank 28.

A connecting line 40 is arranged between the lifting. side and the lowering side hydraulic lines 18, 20, it contains an electrically controlled first stop valve 42. The first stop valve 42 contains a blocking position in which no through fluid flow takes place in both directions and an open position in which a through fluid flow is permitted in both directions. Moreover the connecting line 40 contains a controllable pressure limiting arrangement 43 with a pressure limiting valve 44, that opens in the direction of the lowering side hydraulic line 20 over a control line 46. The control pressure or the threshold pressure to open the pressure limiting valve 44 can be controlled by a controller 48 of the pressure limiting arrangement 43.

Moreover a position sensor 50 is connected to a piston rod 52 of the hydraulic cylinder 10 and transmits a sensor signal to the control unit 54 which reproduces the position of the hydraulic piston 12. The control unit 54 is connected to a switching arrangement 56 by means of which the control unit 54 and thereby with the hydraulic spring support system can be activated.

Moreover a second lowering side hydraulic line 58 is provided that leads from the first lowering side hydraulic line 20 to the hydraulic fluid tank 28 and is provided with a second stop valve 60, where the first and the second stop valve 42, 60 may be configured identically.

According to FIG. 1, the semi-active spring support system is configured as a demand controlled spring support system in which a volume flow flows, according to demand, from the control implement 22 to the hydraulic cylinder 10 of the boom 70 over a load holding valve 34. Thereby the control implement 22 is in the closed position and is switched, according to demand, into the corresponding other positions by the control unit 54.

If the control for the semi-active spring support system is activated by the control unit 54, then the original position of the boom 70 is retained as a guide magnitude that must be maintained (target value) and the control unit determines from this guide magnitude and the actual, measured position (control magnitude) the deviation (control difference) from each other, in order to perform the control of the pressure limiting valve 44 on this basis and to adjust the magnitude of the volume flow by the control implement 22 by means of further target impacts.

In order for the hydraulic piston 12 of the hydraulic cylinder 10 to move on the basis of disturbance magnitude acting upon it, the stop valves 42, 60 must be switched into their open positions.

The pressure that is to be applied to the lifting side of the hydraulic cylinder 10 is controlled by the control unit 54 according to the demand over the electrically controlled pressure limiting valve 44.

If the control unit 54 establishes that the boom 70 has sunk too low, the pressure limiting valve 44 is adjusted to a higher value and the control implement 22 is opened, so that the pressure on the lifting side of the hydraulic cylinder 10 increases under the effect of the flowing volume flow and the hydraulic cylinder 10 is extended.

If the control unit 54 establishes that the boom 70 has been raised too high, the pressure limiting valve 44 is adjusted to a lower value, so that the pressure on the lifting side of the hydraulic cylinder 10 is reduced and the hydraulic piston 12 is retracted. The hydraulic fluid that then flows from the lifting side of the hydraulic cylinder 10 over the pressure limiting valve 44 and the first stop valve 42 to the lowering side of the hydraulic cylinder 10, flows from that point over the second stop valve 60 to the hydraulic fluid tank 28.

Upon an impact that causes the hydraulic piston 12 to retract, the hydraulic fluid is displaced by the hydraulic piston 12 from the lifting side of the hydraulic cylinder 10 and drains off over the pressure limiting valve 44 and over the stop valves 42, 60. Due to the volume of hydraulic fluid displaced the boom 70 is lowered, that, in turn, is recognized by the control unit 54 as a control difference, whereupon the control unit 54 increases the opening pressure of the pressure limiting valve 44 and brings the control implement 22 into the lifting position, so that a volume flow flows to the lifting side of the hydraulic cylinder 10 whereby the adjusting impact are determined by the control unit 54 in accordance with the control difference. On the basis of the increase in the opening pressure and the volume flow flowing from the control implement 22, the boom 70 is again raised until the control difference has been reduced to zero or to a predetermined threshold value.

In this case it is conceivable that the stop valve 42 be closed in order to accelerate the lifting process so that no hydraulic fluid can drain off from the lifting side of the hydraulic cylinder 10 to the hydraulic tank 28.

Upon an impact that causes the hydraulic cylinder 10 to extend, the hydraulic fluid is unloaded on the lifting side of the hydraulic cylinder 10 by the movement of the hydraulic piston 12 and a volume increase of the lifting side chamber 14 takes place since hydraulic fluid is displaced to the hydraulic fluid tank 28 from the lowering side chamber 16. This raising of the boom 70 is recognized by the control unit 54 as a control difference and the control implement 22 is brought into the lifting position in order to fill the resulting volume on the lifting side of the hydraulic cylinder 10 by means of a volume flow. On the basis of the added hydraulic fluid volume the boom 70 still remains lifted, that still is recognized by the control unit 54 as a control difference, whereupon the control unit 54 reduces the opening pressure of the pressure limiting valve 44, in that the control unit 54 determines the adjustment magnitude according to the control difference. Beyond that the control unit 54 again switches the control implement 22 into the closed position. On the basis of the reduction of the opening pressure hydraulic fluid drains off from the lifting side of the hydraulic cylinder 10 over the pressure limiting valve 44 and the boom 70 is lowered until the control difference has been reduced to zero or to a predetermined threshold value.

It is also conceivable that after the lifting of the boom 70 the volume flow direction of the flow is reversed in order to accelerate the lowering of the boom 70, in that the control unit 54 switches the control implement 22 into a lowering position and closes the stop valves 42, 60.

The control implements 54 and stop valves 42, 60 shown in FIG. 1 are shown as controlled electrically, but may be controlled pneumatically, hydraulically, or in any other way.

FIG. 2 shows a loading implement 61 in the form of a telescopic loader. The loading implement 61 is provided with a frame 62, that is carried by a front axle 64 provided with front drive wheels 63 and a rear axle 68 provided with rear drive wheels 66.

The loading implement 61 is provided with a boom 70 that is connected in joints to the frame 62, free to pivot, about a pivot axis 72 arranged parallel to the drive axles 64, 68.

The boom 70 is configured as a telescopic boom and is provided with an operating head 76 at its free end 74 with which a loading tool 80 can be taken up by means of a tool holder 78, free to pivot, about the operating head 76. The boom 70 can be retracted and extended telescopically by an adjusting cylinder (not shown) arranged in the interior of the boom 70. The boom 70 can be pivoted by means of the hydraulic cylinder 10. The hydraulic cylinder 10 is connected to the frame 62 at a first end, preferably on the piston side, free to pivot about a pivot axis 82, and at a second end to the boom 70 preferably on the rod side, free to pivot about a pivot axis 84. Moreover a further hydraulic cylinder 86 in the interior of the boom 70 is arranged in the region of the free end 74. The hydraulic cylinder 86 is used as tilting cylinder for the tool holder 78 that is arranged, free to pivot, at the operating head 76 where the tool holder 78 can be pivoted by means of a tilting linkage 88 arranged at the operating head 76 and connected with the hydraulic cylinder 86.

The hydraulic cylinder 10, arranged for the pivoting of the boom 70, is provided with a pressure sensor 90 by means of which a pressure predominating in the lifting side of the hydraulic cylinder 10 can be detected. Moreover the hydraulic cylinder 10 is provided on the rod side with a position sensor 50, by means of which an extended position of the hydraulic cylinder 10 can be detected. The pivoted position (pivot angle) of the boom 70 can be determined by the extended position detected by the position sensor 50. Alternatively a position sensor, not shown, configured as an angle of rotation transmitter can be arranged on the pivot axis 72 of the boom 70, in order to determine the pivoted position of the boom 70.

The hydraulic cylinder 86 arranged for the pivoting of the tool holder 78 is provided on its lifting side with a pressure sensor 94, by means of which a pressure predominating in the lifting side chamber of the hydraulic cylinder 86 can be detected. Depending on the configuration and arrangement of the tilting linkage 88 the hydraulic cylinder 86 can also be provided with a pressure sensor 94 on its rod side, by means of which a pressure predominating in its rod side chamber can be detected. The deciding factor is that the pressure can be detected that must be developed in the hydraulic cylinder 86 in order to hold a load acting upon the loading tool 80.

The boom 70 is provided with a first and a second boom section 96, 98, where the second boom section 98 is supported in bearings in the interior of the first boom section 96, free to retract or extend. A further position sensor 100 is arranged at one end of the first section 96 of the boom by means of which the extended position of the second section 98 of the boom can be detected.

Moreover the boom 70 is provided with a strain gage 102, by means of which the bending deflection of the boom 70 can be detected. The strain gage 102 is arranged, for example, on the upper side of the first section 96 of the boom at the level of the pivot axis 84, since the greatest bending deflection under load can be expected at that location.

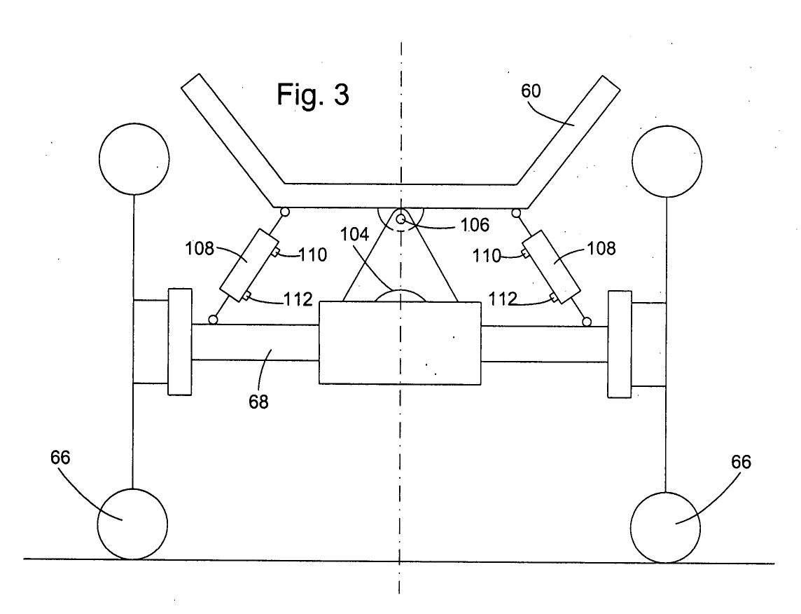

A further strain gage 104 is provided on the rear axle 68 of the loading implement 61, as shown in FIG. 3. The rear axle 68 is preferably connected to the frame 62 by means of a self-aligning bearing 106 (FIG. 3). The strain gage 104 is preferably arranged at the center of the rear axle 68, since the greatest bending deflection under load is to be expected at that location.

In a further embodiment the frame 62 is connected to the front and rear axle 68 by means of hydraulically operated actuators 108. For the sake of clarification this is shown in FIG. 3 for the rear axle 68. The hydraulic actuators 86 are configured as double-acting hydraulic cylinders and are equipped with pressure sensors 110, 112 on their lowering as well as lifting sides, by means of which the pressure on the lowering side as well as on the lifting side of the actuators 108 can be detected.

The devices for the determination of the loading conditions of the boom 70 of the loading implement 61 described so far, such as pressure sensors 90, 94, 110, 112, position sensors 50, 100 and strain gages 102, 104 are intended to provide a selection of various possibilities. All devices shown, 50, 90, 94, 100, 102, 104, 110, 112 are connected electronically to the control unit 54 which generates signals for the correction of the pressure limit on the pressure limiting arrangement 43 as a function of the signals transmitted by the devices 50, 90, 94, 100, 102, 104, 110, 112. Here it is obviously not required that all the devices 50, 90, 94, 100, 102, 104, 110, 112 be arranged together in order to determine the change in the loading condition of the boom 70 or those of the hydraulic cylinder 10. For the sake of a clear illustration, however, all of the devices 50, 90, 94, 100, 102, 104, 110, 112 described are arranged on the same loading implement 61.

In the following several approaches for the determination of changes in the loading condition of the boom 70 shall be explained in greater detail, these changes are used in connection with a change in the spring support performance of the hydraulic arrangement.

An embodiment considers the bending deflection of the rear axle 68 as a measure for the loading of the boom 70. This bending deflection of the rear axle 68, supported on self-aligning bearings, is measured by means of the strain gage 104. As soon as changes in the loading conditions of the boom 70 occur, this affects the bending deflection of the rear axle 68. A control signal can be generated by means of a threshold value estimate predetermined and implemented in the control unit 54, this signal is a function of the signal transmitted by the strain gage 104 to the control unit 54. The control signal is generated by the control unit 54 by means of appropriate software and hardware that can easily be installed by anyone skilled in the art and conducted to the pressure limiting arrangement 43, in order to correct the threshold value for the pressure limiting arrangement that determines the opening of the pressure limiting valve 44. Thereby the spring support performance is made to comply with the new loading situation at the boom 70. This method of approach for the threshold value estimate is also followed analogously in the following embodiments.

Another possibility consists of the detection of the bending deflection of the boom 70 at another appropriate location by the strain gage 102, at the level of the pivot axis 84. The greater the bending deflection of the boom 70, the higher must be the loading of the boom on the basis of the geometrical relations that have been stored by the loading implement 61 on the lifting side of the hydraulic cylinder 10. If the boom 70 is extended then the additional loading also becomes applied to the hydraulic cylinder 10. Therefore the change in the loading condition on the boom 70 can be determined solely on the basis of the signal transmitted by the strain gage 102. The determination of the change in the loading can become even more precise with an additional consideration of the data from the position sensors 50, 100, since the exact position of the second section 98 of the boom and the pivoted position of the boom 70 and thereby the lever relations at the loading implement 61 are considered. Therefore by a further threshold value estimate implemented in the control unit 54 the change in the loading at the boom 70 or at the loading implement 61 can be determined with a high degree of accuracy and a corresponding control signal generated for the conformity or correction of the spring support performance of the electrical arrangement as a function of the signal transmitted from the strain gage 102 to the control unit 54 and, if necessary, also upon the signals transmitted from the position sensors 50, 100 to the control unit 54.

A further possibility results from the detection of the pressure on the lifting side of the hydraulic cylinder 10 by means of the pressure sensor 90. The measured pressure that must be developed to raise a load applied to the loading implement 80 can be used as a measure for the load on the boom 70 or the loading on the hydraulic cylinder 10. The generation of a control signal for the pressure limiting arrangement 43 can be performed analogously to the previous embodiments by means of a threshold value estimate and, as noted above, as a function of the signal transmitted by the pressure sensor 90 to the control unit 54.

A further possibility results from the detection of the pressure on the lifting side of the actuator/hydraulic cylinder 86 by means of the pressure sensor 94, if necessary in combination with a determination of the position or the location of the boom by means of the position sensors 50, 100. The measured pressure that must be developed for the lifting, holding or tilting of a load applied to the loading tool 80 is also a direct measure for the change in the loading condition. By including additional signals of the position sensors 50, 100 not only loading conditions of the boom 70 as a function of the load on the loading tool 80 can be considered, but also as a function of geometric changes at the boom 70 that affect the loading on the hydraulic cylinder 10. The generation of a control signal for the pressure limiting arrangement 43 can be performed analogously to the preceding embodiments by a further predetermined threshold value estimate implemented in the control unit 54.

Another possibility consists of detecting the pressure in the actuators 108 by means of the pressure sensors 110, 112. Such an arrangement of actuators 108 can be applied, among other possibilities, to permit an evaluation of the capacity to tilt or heel of the frame 62 to the side of the longitudinal direction of the loading implement. Moreover these actuators 108 can also be used to apply spring suspension to one or more drive axles 64, 68 of the loading implement 61 in order to improve the operating comfort. The pressure detected by the pressure sensors 112 on the lifting side of the actuators 108 can also be utilized as a measure for the change in a loading condition of the boom 70 where, if necessary, simultaneously the pressure detected by the pressure sensors 110 on the lowering side of the actuators 108 can be considered, in order to compensate for a falsification of the measurement results due to a possible strain on the actuators 108. Thereby the generation of a control signal for the pressure limiting arrangement 43 can be performed analogously to the preceding embodiments by a further predetermined threshold value estimate implemented in the control unit 54 and as a function of the signals transmitted by the pressure sensors 112 to the control unit 54 and, if necessary, also as a function of the signals transmitted to the control unit 54 from the pressure sensors 110.

The correction of the pressure limiting arrangement 43 is preferably performed in such a way that the controller 48 is controlled by the control signal generated by the control unit 54 and as a result the pressure limiting value or the pressure threshold value is changed. Here the pressure limit value is changed in such a way that upon a reduction of the loading condition of the boom the pressure limiting value or the pressure threshold value is reduced, so that the hydraulic spring support arrangement can react to reduced impact and thereby the stiffened spring performance brought about by the change in the loading condition of the boom 70 is corrected. This may be a simple control arrangement or a closed loop control circuit.

Although the invention has been described only on the basis of the embodiments described above, anyone skilled in the art will perceive many varied alternatives, modifications and variations in the light of the above description and the drawing, all of which fall under the present invention. In that way, for example, the loading implement 61 can be equipped with further devices that permit a determination of the loading condition of the boom 70.

1. A loading implement with a hydraulic arrangement for the spring support of a boom, the hydraulic arrangement having at least one hydraulic conveying device, a hydraulic tank, a first hydraulic cylinder and a control implement for lifting and lowering the boom, as well as a controllable pressure limiting arrangement that is arranged and configured in such a way that excursion movements of the first hydraulic cylinder can be equalized and that a control unit is provided for the control of the pressure limiting arrangement, the improvement comprising:
devices for detecting changes in the loading conditions of the boom and generating a signal representing the loading conditions for processing by the control unit.

2. A loading implement according to claim 1, wherein the devices include at least one strain gage arranged on one or more axles of the loading implement.

3. A loading implement according to claim 1, wherein the devices include at least one strain gage arranged on the boom of the loading implement.

4. A loading implement according to claim 1, wherein the devices include at least one pressure sensor arranged on the hydraulic cylinder.

5. A loading implement according to claim 1, the devices include at least one pressure sensor arranged on a second hydraulic cylinder of the loading implement in particular.

6. A loading implement according to claim 1, wherein the devices include at least one position sensor for the detection of the position or location of the boom arranged on the boom and/or on one of the hydraulic cylinders of the loading implement.

7. A loading implement according to claim 1, wherein the devices include at least one pressure sensor arranged on one or more hydraulic or pneumatic actuators arranged between a frame and axles of a loading implement.
